(19) United States
(12) Patent Application Publication
(10) Pub. No.: US 2020/0012573 A1
(43) Pub. Date: Jan. 9, 2020

(54) DATA BACKUP METHOD AND TERMINAL

(71) Applicant: Huizhou TCL Mobile Communication Co., Ltd, Huizhou, Guangdong (CN)

(72) Inventors: Xin Li, Huizhou, Guangdong (CN); Yu Zheng, Huizhou, Guangdong (CN)

(21) Appl. No.: 16/314,856

(22) PCT Filed: Jul. 14, 2017
(86) PCT No.: PCT/CN2017/092943

§ 371 Date: Jan. 2, 2019

(30) Foreign Application Priority Data
Jul. 29, 2016 (CN) 201610625116.3

(51) Int. Cl. G06F 11/14; H04L 29/06

(52) U.S. Cl. CPC G06F 11/1464; H04L 67/40

(57) ABSTRACT

A data backup method and a terminal are disclosed in the present disclosure. The data backup method including: receiving a backup trigger instruction; starting a photographing function in respond to the backup trigger instruction, and acquiring a displayable information including a preset operation instruction by photographing; decoding a operation instruction from the displayable information; and performing a data backup process according to the operation instruction. Through this way, the present disclosure provides a data backup method. The method enables emergency transmission and backup of data when the screen or other input interface is inoperable.

### TECHNICAL FIELD

The present disclosure relates to the field of communication and display technologies, and in particular to a data backup method and a terminal.

### BACKGROUND

In the era of mobile Internet, with the development of technology, more and more large-screen electronic products that can be photographed without physical buttons, wireless Internet access, and touchable operation have entered people's lives. For the pursuit of the ultimate experience of the big screen, but also for the consideration of increasing market occupancy. While manufacturers are pursuing larger and thinner electronic devices, larger screen ratios are becoming one of the conditions for people to measure a device. Although it is convenient for the user experience, if the screen of the device is damaged or the communication function is damaged, the specific hardware switch is damaged, or the internal circuit is faulty, the screen may be displayed but cannot be operated. If the touch screen cannot be replaced in time, many important data in the device cannot be taken out, and the data cannot be transferred, which brings inconvenience to the user.

### SUMMARY

The present disclosure provides a data backup method that enables emergency transmission and backup of data when the screen or other input interface is inoperable.

To solve the aforesaid technical problem, a technical solution adopted by the present disclosure provides a data backup terminal, including: a processor and a transceiver connected to the processor; wherein the processor is configured to: receive a backup trigger instruction through the transceiver; start a photographing function in response the backup trigger instruction, and then acquire a displayable information including a preset operation instruction by photographing; decode an operation instruction from the displayable information; and perform a data backup process according to the operation instruction.

To solve the aforesaid technical problem, a technical solution adopted by the present disclosure provides a data backup terminal, including a processor, a transceiver and a display, wherein the processor is connected to the transceiver and the display; and the processor is configured to: send a backup trigger instruction and receive a data to be backed up sent by a backup source device in response to an operation instruction by the transceiver; and display a displayable information including a preset operation instruction through the display.

To solve the aforesaid technical problem, a technical solution adopted by the present disclosure provides a data backup method, including the following steps: receiving a backup trigger instruction; starting a photographing function in respond to the backup trigger instruction, and acquiring a displayable information including a preset operation instruction by photographing; decoding a operation instruction from the displayable information; and performing a data backup process according to the operation instruction; or, sending a backup trigger instruction; displaying a displayable information including a preset operation instruction; and receiving a data to be backed up sent by a backup source device in response to the operation instruction.

The beneficial effects of the disclosure are: the present disclosure provides a data backup method and a terminal, which pre-set a backup processing flow when a screen cannot be operated when a backup source device is available. After receiving the backup trigger instruction, the photographing function can be started, the displayable information including the preset operation instruction can be obtained, the operation instruction can be decoded, and the data backup process can be executed. Thus the method enables an urgent transfer and backup of data when the screen or other input interface of a terminal is inoperable.

### BRIEF DESCRIPTION OF THE DRAWINGS

FIG. 1 is a flow chart showing the configuration of an embodiment of a data backup method according to the present disclosure;

FIG. 2 is a flowchart of a backup source device of an embodiment of a data backup method according to the present disclosure;

FIG. 3 is a flowchart of a backup receiving device of an embodiment of a data backup method according to the present disclosure;

FIG. 4 is a schematic structural diagram of an embodiment of a data backup terminal according to the present disclosure;

FIG. 5 is a schematic structural diagram of another embodiment of a data backup terminal according to the present disclosure;

FIG. 6 is a schematic structural diagram of an embodiment of a data backup device according to the present disclosure;

FIG. 7 is a schematic structural diagram of another embodiment of a data backup device according to the present disclosure;

FIG. 8 is a schematic structural diagram showing an embodiment of a storage device with memory function of the present disclosure.

### DETAILED DESCRIPTION

Hereinbelow, technical solutions of the embodiments of the present disclosure will be described clearly and fully with reference to the attached drawings illustrating the embodiments of the present disclosure. Obviously, the embodiments described herein are only a part of but not all of the embodiments of the present disclosure. All other embodiments that can be obtained by those of ordinary skill in the art from the embodiments of the present disclosure without making creative efforts shall fall within the scope of the present disclosure.

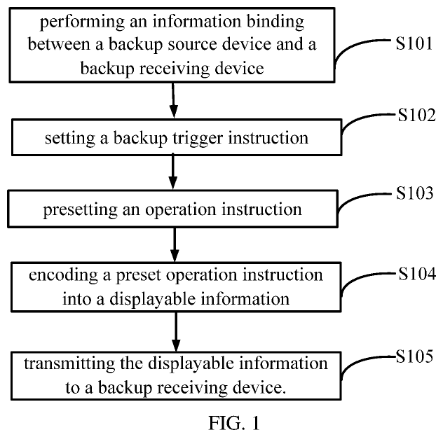

Please refer to FIG. 1. FIG. 1 is a flow chart showing the configuration of an embodiment of a data backup method according to the present disclosure. As shown in FIG. 1, the configuration process can include the following steps:

S101, performing an information binding between a backup source device and a backup receiving device.

In a preferred embodiment, when the backup source device is available, the backup receiving device can be used as an information backup trigger entity of the backup source device, and the device information of the backup source device and the backup receiving device can be bound in advance to confirm each other during subsequent data backup.

In a preferred embodiment, a binding mode may include, but is not limited to, mutually storing device information and device configuration information of the other party, so as to mutually confirm each other when interacting. The device information may include at least one of the following information: an IMEI, a MAC address, a Bluetooth ID, an administrator account, a user account, an identifier code of a hardware component, an identifier code of a hardware accessory, and a combination thereof.

In other embodiments, the device information of the backup source device and the backup receiving device can be algorithmically encrypted and encoded into one or more displayable information, and stored on a third-party intermediary medium, and decoded and mutually confirmed by using a photographing function of the backup source device and the backup receiving device to scan. The displayable information may be a specific set of information stream identified from the information streams acquired from a camera. In a preferred embodiment, the displayable information is preferably a barcode.

In other embodiments, an authentication information issued by the third-party intermediary or device can be confirmed by each other.

S102, setting a backup trigger instruction.

In a preferred embodiment, when the backup source device is available, a trigger instruction information of a startup backup operation sent by the backup receiving device to the backup source device may be pre-configured. A unique identifier of the backup source device and the configuration information of the backup receiving device may be encrypted to generate a corresponding backup trigger instruction, which may include but is not limited to characters, codes, and machine language codes.

Similarly, the above step may be completed by any one of the backup source device and the backup receiving device, and preferably sent to the other one for storage, or it can be completed by a third-party intermediary or device, and sent to the backup source device and the backup receiving device, or directly stored in the third-party intermediary or device.

S103, presetting an operation instruction.

In a preferred embodiment, when the backup source device is available, the operation instruction when the screen is inoperable can be preset.

The operation instruction may include a backup operation instruction and a connection transfer instruction. The backup operation instruction may include, but is not limited to, selection of function to be backed up, function data selection, database creation of information to be backed up, and storage path of data to be backed up.

Similarly, the above step may be completed by any one of the backup source device and the backup receiving device, or may be completed by the third-party intermediary or device, and sent to the backup source device and the backup receiving device, or directly stored in the third-party intermediary or device.

In a preferred embodiment, the above step can be performed by the backup source device and the following steps can be further performed by the backup source device.

S104, encoding a preset operation instruction into a displayable information.

In a preferred embodiment, the operation instruction preset in S103 may be at least partially encoded into one or more displayable information. The displayable information may be a specific set of information stream identified from the information streams acquired from the camera. In this embodiment, the displayable information is preferably a barcode.

S105, transmitting the displayable information to a backup receiving device.

In a preferred embodiment, the displayable information may be sent to the backup receiving device to complete the transmission. In other embodiments, the displayable information can be sent to the third-party intermediary or device, or generated directly by the third-party intermediary or device.

It is worth noting that, the backup receiving device may further decode the displayable information to obtain the operation instruction, and may re-set the specific execution parameter of the operation instruction according to the specific situation (for example, a storage path of the data to be backed up in the backup source device, a file name, a generated time of a selected data to be backed up, a setting information of a upload path, a storage path of the data to be backed up on the backup receiving device, etc.), and regenerate the displayable information according to a specific reset execution parameter.

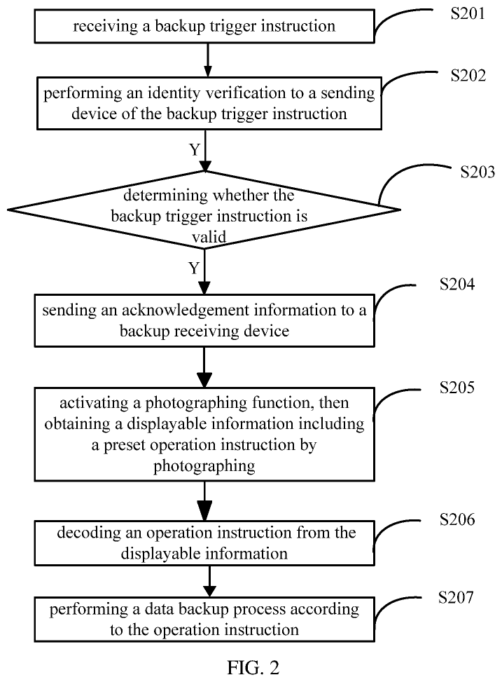

Please refer to FIG. 2. FIG. 2 is a flowchart of a backup source device of an embodiment of a data backup method according to the present disclosure. As shown in FIG. 2, the data backup method may include the following steps:

5201, receiving a backup trigger instruction.

In a preferred embodiment, when a backup source device is inoperable, the user can send a startup backup trigger instruction information by receiving the backup accepting device.

The backup trigger instruction may include but is not limited to characters, codes, and machine language codes. The transmission form of the backup trigger instruction may include, but is not limited to, a short message, a multimedia message, an instant messaging software message, and various hardware communication information (including but not limited to Bluetooth communication, NFC communication, infrared communication, Wi-Fi communication, etc.).

S202, performing an identity verification to a sending device of the trigger instruction.

In a preferred embodiment, after receiving the backup trigger instruction, the backup source device can perform an identity verification on the sending device of the triggering instruction according to a binding information of the backup source device and the backup receiving device, including but not limited to device information and device configuration information of both parties. In other embodiments, the backup source device can send its own device information to the backup receiving device for a two-way authentication. Alternatively, the backup source device and the backup receiving device may send respective device information to a third-party intermediary or device for confirmation by the third-party intermediary or device.

The device information may include at least one of the following information: an IMEI, a MAC address, a Bluetooth ID, an administrator account, a user account, an identifier code of a hardware component, an identifier code of a hardware accessory, and a combination thereof.

S203, determining whether the backup trigger instruction is valid.

In a preferred embodiment, after determining that the sending device of the backup trigger instruction is a bound backup receiving device, a validity verification of the backup trigger instruction can further be performed according to a preset backup trigger instruction. That is, the backup trigger instruction can be restored by a specific decoding to be performed a match with the preset backup trigger instruction preset to determine whether the backup trigger instruction is a valid trigger instruction.

The trigger instruction may include, but are not limited to, characters, encodings, and machine language codes.

S204, sending an acknowledgement information to a backup receiving device.

In a preferred embodiment, sending an acknowledgement information to the backup receiving device to start a backup mode with an inoperable screen, after being determined the sending device of the backup trigger instruction is the bound backup receiving device and the backup trigger instruction is the valid trigger instruction.

It should be noted that steps S202-S204 may not be mandatory steps for implementing the present disclosure, and those skilled in the art may modify or omit according to actual usage.

S205, activating a photographing function, then obtaining a displayable information including a preset operation instruction by photographing.

In a preferred embodiment, when the backup source device starts the backup mode, the user can acquire displayable information including the preset operation instruction by starting a photographing function or reading the two-dimensional code function. Wherein the displayable information may be a barcode.

S206, decoding an operation instruction from the displayable information.

In a preferred embodiment, the operation instruction can be specifically decoded and restored, after the displayable information including the preset operation instruction is acquired.

The operation instruction can include a backup operation instruction and a connection transfer instruction. The backup operation instruction may include, but is not limited to, selection of function to be backed up, function data selection, database creation of information to be backed up, and backup data storage path.

S207, performing a data backup process according to the operation instruction.

In a preferred embodiment, the user can sort and package a data to be backed up in a particular location based on the backup operation instructions.

After the backup operation instruction is completed, a connection can be established between the backup source device and the backup receiving device according to the connection transfer instruction, and the data to be backed up which has been packaged can be sent to the backup receiving device to complete the transmission.

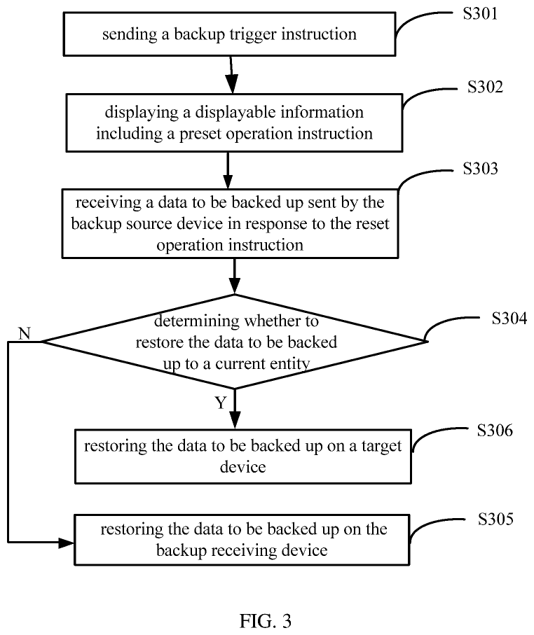

Please refer to FIG. 3. FIG. 3 is a flowchart of a backup receiving device of an embodiment of a data backup method according to the present disclosure. The data backup method may include the following steps:

S301, sending a backup trigger instruction.

In a preferred embodiment, when a backup source device is inoperable, the user can send a startup backup trigger instruction information to the backup source device through the backup accepting device.

The backup trigger instruction may include but is not limited to characters, codes, and machine language codes. The transmission form of the backup trigger instruction may include, but is not limited to, a short message, a multimedia message, an instant messaging software message, and various hardware communication information (including but not limited to Bluetooth communication, NFC communication, infrared communication, Wi-Fi communication, etc.).

In other embodiments, when a two-way authentication is required, a device identifier sent by the backup source device may also be authenticated, and a verification process may be completed by the backup receiving device or a third-party intermediary or device.

S302, displaying a displayable information including a preset operation instruction.

In a preferred embodiment, the backup accepting device can receive an acknowledgement information transmitted by the backup source device and display the displayable information including the preset operation instruction in response to the acknowledgement information. As mentioned above, the displayable information displayed by the backup receiving device may be received from the backup source device or a third-party intermediary or device, or may be generated by the backup receiving device itself or generated after resetting the displayable information received by the backup receiving device itself. Of course, the displayable information can be displayed by the third-party intermediary or device.

S303, receiving a data to be backed up sent by the backup source device in response to the operation instruction.

In a preferred embodiment, the user can acquire the displayable information including the preset operation instruction by activating a photographing function or a function reading a two-dimensional code, and reducing the displayable information to an operation instruction by specific decoding.

The operation instruction may include a backup operation instruction and a connection transfer instruction. The backup operation instruction may include, but is not limited to, selection of function to be backed up, function data selection, database creation of information to be backed up, and backup data storage path.

The connection source device can be connected to the backup source device according to the connection transfer instruction of the backup source device, and then can accept the data to be backed up.

S304, determining whether to restore the data to be backed up to a current entity.

In a preferred embodiment, after the data to be backed up of the backup source device is completely received, the backup receiving device may analyze a backup database to determine whether the current entity meets a data restoration condition.

The specific condition may include, but is not limited to, data integrity check, whether it has a same system as the backup source device, and whether there is a same database index information as a backup source device information. The database index information may include but is not limited to a same file directory, file name, file size, and the like. When it is judged that all the above conditions are met, the user can be asked whether to choose to restore the information to be backed up to the current entity. If the determination result is yes, S306 can be performed, otherwise S305 can be performed.

S305, restoring the data to be backed up on a target device.

In a preferred embodiment, if it is determined that the current entity does not satisfy the data restoration condition in S304, the backup receiving device can be regarded as an intermediate device, and the data to be backed up from the backup source device can be transmitted to other entities through other transmission methods, and restore the data to be backed up to a data form matching a new entity to complete the data backup.

S306, restoring the data to be backed up on the backup receiving device.

In a preferred embodiment, if it is determined that the current entity satisfies the data restoration condition in S304, the data to be backed up can be restored to the backup receiving device, and the data backup is completed.

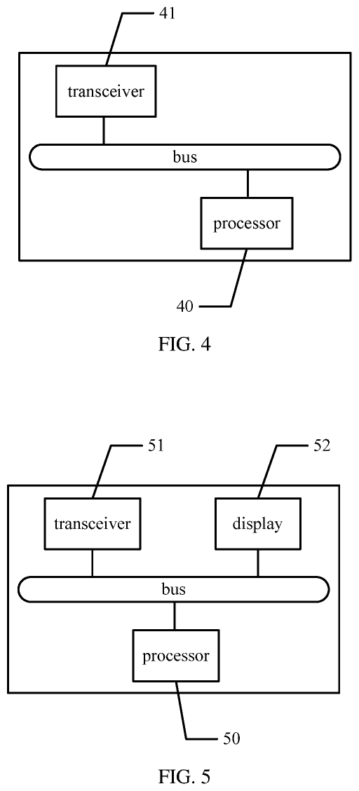

Please refer to FIG. 4. FIG. 4 is a schematic structural diagram of an embodiment of a data backup terminal according to the present disclosure. The terminal provided by the embodiment of the present disclosure may be an electronic device that can be used in the field of wireless communication, such as a smart phone or a tablet computer. In the present embodiment, the terminal may include a processor 40 and a transceiver 41.

The processor 40 may be configured to perform an information binding on the backup source device and the backup receiving device, set a backup trigger instruction, pre-set an operation instruction, and encode the operation instruction preset into a displayable information. The displayable information may be a barcode, and send the displayable information to a backup receiving device or a third-party intermediary device through the transceiver 41.

Optionally, the processor 40 may further be configured to receive a backup trigger instruction by the transceiver 41, and perform an identity verification on a sending device of the backup trigger instruction according to a binding information to determine whether the sending device of the backup trigger instruction is a bound backup receiving device, and perform a validity verification on a received backup trigger instruction according to a preset backup trigger instruction to determine whether the received backup trigger instruction is a valid trigger instruction. Specifically, the processor 40 is configured to send an acknowledgement information to the backup receiving device by the transceiver 41 after determining whether the sending device of the backup trigger instruction is the bound backup receiving device, and the received backup trigger instruction is the valid trigger instruction.

Optionally, the processor 40 may further be configured to start a photographing function in response to the backup trigger instruction, and then acquire a displayable information including a preset operation instruction by photographing and decode the operation instruction from the displayable information. The displayable information can be a barcode.

Optionally, the processor 40 can further be configured to perform a data backup process according to the operation instruction, which may specifically be sorting and packaging a data to be backed up according to a backup operation instruction, and establishing a connection between the backup source device and the backup receiving device according to a connection transfer instruction and sending a packaged data to be backed up to the backup receiving device through the transceiver 41.

The module terminals of the above-mentioned devices can respectively perform the corresponding steps in the foregoing method embodiments, and therefore, the modules are not described herein. For details, refer to the description of the corresponding steps.

The module terminals of the above-mentioned devices can respectively perform the corresponding steps in the foregoing method embodiments, and therefore, the modules are not described herein. For details, refer to the description of the corresponding steps.

Please refer to FIG. 5. FIG. 5 is a schematic structural diagram of another embodiment of a data backup terminal according to the present disclosure. The terminal provided by the embodiment of the present disclosure may be an electronic device that can be used in the field of wireless communication, such as a smart phone or a tablet computer. In this embodiment, the terminal may include a processor 50, a transceiver 51, and a display 52.

The processor 50 may be configured to transmit a backup trigger instruction through the transceiver, and display a displayable information including a preset operation instruction through the display 52. Specifically, the processor 50 can be configured to receive an acknowledgement information of the backup source device by the transceiver 51, and display the displayable information including the preset operation instruction in response to the acknowledgement information.

Further, the processor 50 can be configured to receive a data to be backed up sent by the backup source device in response to the operation instruction through the transceiver 51, and restore the data to be backed up on the backup source device or a target device other than the backup source device.

The module terminals of the above-mentioned devices can respectively perform the corresponding steps in the foregoing method embodiments, and therefore, the modules are not described herein. For details, refer to the description of the corresponding steps.

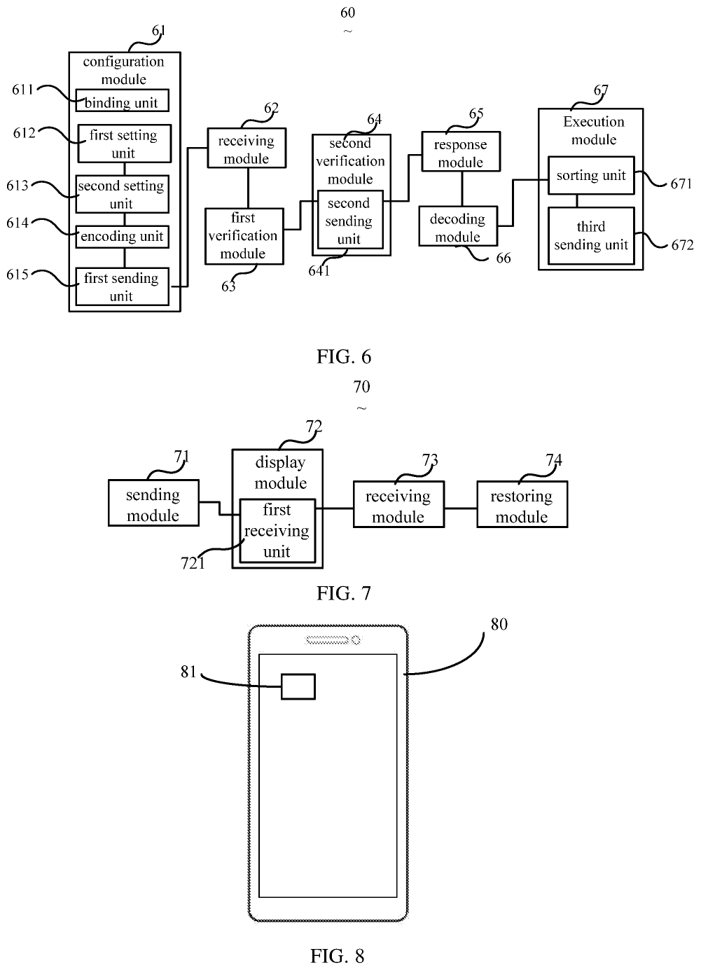

Please refer to FIG. 6. FIG. 6 is a schematic structural diagram of an embodiment of a data backup device according to the present disclosure. In this embodiment, the data backup device 60 may include a configuration module 61, a receiving module 62, a first verification module 63, a second verification module 64, a response module 65, a decoding module 66, and an execution module 67.

Optionally, the configuration module 61 may include: a binding unit 611, a first setting unit 612, a second setting unit 613, an encoding unit 614, and a first sending unit 615.

The binding unit 611 may be configured to perform a information binding on a backup source device and a backup receiving device.

The first setting unit 612 may be configured to set a backup trigger instruction.

The second setting unit 613 may be configured to preset an operation instruction.

The encoding unit 614 may be configured to encode a preset operation instruction into a displayable information, wherein the displayable information may be a barcode.

The first sending unit 615 may be configured to send the displayable information to the backup receiving device or a third-party intermediary device.

The receiving module 62 may be configured to receive the backup trigger instruction.

The first verification module 63 may be configured to perform identity verification on a sending device of the backup trigger instruction according to a binding information, to determine whether the sending device of the backup trigger instruction is a bound backup receiving device.

The second verification module 64 may be configured to perform a validity verification on a received backup trigger instruction according to a preset backup trigger instruction to determine whether the received backup trigger instruction is a valid trigger instruction. The second verification module 64 may further include a second sending unit 641 which may be configured to send an acknowledgement information to the backup receiving device after the sending device of the backup trigger instruction is confirmed to be the bound backup receiving device and the received backup trigger instruction is confirmed to be a valid trigger instruction.

The response module 65 may be configured to start a photographing function in response to the backup trigger instruction, and then acquire the displayable information including the preset operation instruction by photographing, wherein the displayable information may be a barcode.

The decoding module 66 may be configured to decode the operation instruction from the displayable information.

The execution module 67 may be configured to execute a data backup process according to the operation instruction, and may further include: a sorting unit 671 and a third sending unit 672.

The sorting unit 671 may be configured to sort and package the backup data according to the backup operation instruction.

The third sending unit 672 may be configured to establish a connection between the backup source device and the backup receiving device according to a connection transfer instruction, and send a packaged data to be backed up to the backup receiving device.

The device can perform the steps performed by the terminal in the above method. For related content, please refer to the detailed description in the above method, which will not be described here.

Please refer to FIG. 7. FIG. 7 is a schematic structural diagram of another embodiment of a data backup device according to the present disclosure. In this embodiment, the data backup device 70 may include a sending module 71, a display module 72, a receiving module 73, and a restoring module 74.

The sending module 71 may be configured to send a backup trigger instruction.

The display module 72 may be configured to display a displayable information including a preset operation instruction, may include a first receiving unit 721 which may be configured to receive an acknowledgement information of the backup source device, and display a displayable information including the preset operation instruction in response to the acknowledgement information.

The receiving module 73 may be configured to receive a data to be backed up sent by the backup source device in response to an operation instruction.

The restoring module 74 may be configured to restore the data to be backed up on the backup source device or a target device other than the backup source device.

The apparatus can perform the steps performed by the terminal in the above method. For related content, please refer to the detailed description in the above method, which will not be described here.

Please refer to FIG. 8. FIG. 8 is a schematic structural diagram showing an embodiment of a storage device with memory function of the present disclosure. The storage device 80 can store a program file 81 capable of implementing all of the above methods. The program file 81 may be stored in a storage device 80 in the form of a software product, including instructions for causing a computer device (can be a personal computer, server, or network device, etc.) or processor to perform all or part of the steps of the methods of various embodiments of the present disclosure. The foregoing storage device 80 may include: a medium that can store program codes, such as a USB, a mobile hard disk, a read-only memory (ROM), a random access memory (RAM), a hard disk, or a disk, and the like, or a terminal device such as a computer, a server, a mobile phone, or a tablet.

In summary, those skilled in the art can easily understand that the present disclosure provides a data backup method and a terminal, which are preset to set a backup processing flow when the screen cannot be operated when a backup source device is available. After receiving a backup trigger instruction, the photographing function may be started, a displayable information including a preset operation instruction can be acquired, an operation instruction can be decoded, and a data backup process can be executed, thereby realizing emergency transmission and backup of a data.

The above description is only some embodiments of the present disclosure, and thus does not limit the scope of the patent of the present disclosure. The equivalent structure or equivalent process transformations made by the present specification and the drawings are directly or indirectly applied to other related technical fields, and are included in the scope of patent protection of the present disclosure.

1. A data backup terminal, comprising:
a processor and a transceiver connected to the processor; wherein the processor is configured to:
receive a backup trigger instruction through the transceiver;
start a photographing function in response the backup trigger instruction, and then acquire a displayable information comprising a preset operation instruction by photographing;
decode an operation instruction from the displayable information; and
perform a data backup process according to the operation instruction.

2. The terminal according to claim 1, wherein, before receiving the backup trigger instruction through the transceiver, the processor is configured to:
perform an information binding on a backup source device and a backup receiving device;
after receiving the backup trigger instruction through the transceiver, the processor is configured to:
perform an identity verification on a sending device of the backup trigger instruction according to a binding information, to determine whether the sending device of the backup trigger instruction is a bound backup receiving device.

3. The terminal according to claim 2, wherein, before receiving the backup trigger instruction through the transceiver, the processor is further configured to:
set the backup trigger instruction;
after receiving the backup trigger instruction through the transceiver, the processor is further configured to:
perform a validity verification on the backup trigger instruction received by the transceiver according to a preset backup trigger instruction, to determine whether the backup trigger instruction received by the transceiver is a valid trigger instruction.

4. The terminal according to claim 3, wherein, after performing the validity verification on the backup trigger instruction received by the transceiver according to the preset backup trigger instruction, the processor is configured to:
send an acknowledgement information to the backup receiving device through the transceiver, after determining that the sending device of the backup trigger instruction is the bound backup receiving device, and the backup trigger instruction received by the transceiver is the valid trigger instruction.

5. The terminal according to claim 1, wherein, before receiving the backup trigger instruction through the transceiver, the processor is configured to:
preset the operation instruction,
encode a preset operation instruction into the displayable information, and
transmit the displayable information to the backup receiving device or a third-party mediation device through the transceiver.

6. The terminal according to claim 1, wherein the operation instruction comprises a backup operation instruction and a connection transfer instruction, the processor is further configured to:
sort and package a data to be backup according to the backup operation instruction; and
establish a connection between a backup source device and a backup receiving device according to the connection transfer instruction and send a packaged data to be backed up to the backup receiving device through the transceiver.

7. The terminal according to claim 1, wherein the displayable information is a barcode.

8. A data backup terminal, comprising a processor, a transceiver and a display, wherein the processor is connected to the transceiver and the display; and the processor is configured to:
send a backup trigger instruction and receive a data to be backed up sent by a backup source device in response to an operation instruction by the transceiver; and
display a displayable information comprising a preset operation instruction through the display.

9. The terminal according to claim 8, wherein the processor is configured to:
receive an acknowledgement information of the backup source device through the transceiver, and display the displayable information comprising the preset operation instruction in response to the acknowledgement information.

10. The terminal according to claim 8, wherein the processor is further configured to:
restore the data to be backed up on the backup source device or a target device other than the backup source device.

11. A data backup method, comprising the following steps:
receiving a backup trigger instruction;
starting a photographing function in respond to the backup trigger instruction, and acquiring a displayable information comprising a preset operation instruction by photographing;
decoding a operation instruction from the displayable information; and
performing a data backup process according to the operation instruction;
or, sending a backup trigger instruction;
displaying a displayable information comprising a preset operation instruction; and
receiving a data to be backed up sent by a backup source device in response to the operation instruction.

12. The method according to claim 11, wherein before the step of receiving a backup trigger instruction, the method further comprises:
performing an information binding between a backup source device and a backup receiving device;
after the step of receiving a backup trigger instruction, the method further comprises:
performing an identity verification to a sending device of the backup trigger instruction according to a binding information to determine whether the sending device of the backup trigger instruction is a bound backup receiving device.

13. The method according to claim 12, wherein before the step of receiving a backup trigger instruction, the method further comprises:
setting the backup trigger instruction;
after the step of receiving a backup trigger instruction, the method further comprises:
performing a validity verification on a received backup trigger instruction according to a preset backup trigger instruction to determine whether the received backup trigger instruction is a valid trigger instruction.

14. The method according to claim 13, wherein after the step of performing a validity verification on a received backup trigger instruction according to a preset backup trigger instruction, the method further comprises:
sending an acknowledgement information to the backup receiving device after determining the sending device of the backup trigger instruction is the bound backup receiving device, and the received backup trigger instruction is the valid trigger instruction.

15. The method according to claim 11, wherein before the step of receiving a backup trigger instruction, the method further comprises:
presetting the operation instruction;
encoding a preset operation instruction into the displayable information; and
transmitting the displayable information to the backup receiving device or a third-party mediation device.

16. The method according to claim 11, wherein the operation instruction comprises a backup operation instruction and a connection transfer instruction, the step of performing a data backup process according to the operation instruction comprises:
sorting and packaging a data to be backup according to the backup operation instruction;
establishing a connection between a backup source device and a backup receiving device according to the connection transfer instruction and transmitting a packaged data to be backed up to the backup receiving device.

17. The method according to claim 11, wherein the displayable information is a barcode.

18. The method according to claim 11, wherein the step of displaying a displayable information comprising a preset operation instruction comprises:
receiving a acknowledgement information of a backup source device, and displaying the displayable information comprising the preset operation instruction in response to the acknowledgement information.

19. The method according to claim 11, wherein the method further comprises:
restoring the data to be backed up on the backup source device or a target device other than the backup source device.
